(19) United States
(12) Patent Application Publication
(10) Pub. No.: US 2018/0095550 A1
(43) Pub. Date: Apr. 5, 2018

(54) POSITION DETERMINING TECHNIQUES FOR VIRTUAL REALITY SYSTEMS

(71) Applicant: Intel Corporation, Santa Clara, CA (US)

(72) Inventor: Yehiel Shilo, Jerusalem (IS)

(73) Assignee: Intel Corporation, Santa Clara, CA (US)

(21) Appl. No.: 15/282,919

(22) Filed: Sep. 30, 2016

(51) Int. Cl. G06F 3/0346; G06F 3/01; G06F 3/16

(52) U.S. Cl. CPC G06F 3/0346; G06F 3/162; G06F 3/016; G06F 3/011

(57) ABSTRACT

Technology for determining a position of a device based on an acceleration of the device sensed by an accelerometer, an angular velocity sensed by a gyroscope, and a distance of the device from a fixed magnetic field source determined from a magnetic field strength sensed by a magnetometer.

### BACKGROUND

Virtual reality systems provide location based visual, audio and/or tactile outputs to create a virtual reality environment for a user. Virtual reality headsets typically include a stereoscopic head-mounted display, and optionally stereoscopic speakers and/or haptic feedback elements. To determine location, virtual reality systems typically include one or more accelerometers, gyroscopes, eye tracking sensors, and structured light and image capture systems. Virtual reality systems however are constrained by cost, processing speed and power consumption. The use of accelerometers and gyroscopes alone cannot accurately and economically determine a fixed position of the virtual reality system. Therefore, one or more subsystems such as a fixed constellation of light source and image capture elements can be used to accurately determine the fixed position of the virtual reality systems. However, the additional subsystems typically increase the cost of the device, increase the computation workload and consume additional power.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 is a diagram illustrating a system configured to determine a position and location according with an example;

FIG. 2 is a block diagram of an inertial measurement unit for determining a position and location of a device in accordance with an example;

FIG. 3 is a flow diagram of a method for determining a position and location of a device in accordance with an example;

FIG. 4 is a block diagram illustrating an inertial measurement unit for determining a position and location of a device in accordance with another example; and

FIG. 5 is a block diagram illustrating a system configured to determine a position and location in accordance with another example.

### DESCRIPTION OF EMBODIMENTS

Before invention embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to convey a thorough understanding of various invention embodiments. One skilled in the relevant art will recognize, however, that such detailed embodiments do not limit the overall inventive concepts articulated herein, but are merely representative thereof.

As used in this written description, the singular forms “a,” “an” and “the” include express support for plural referents unless the context clearly dictates otherwise. Thus, for example, reference to “a magnet” includes a plurality of such magnets.

Reference throughout this specification to “an example” means that a particular feature, structure, or characteristic described in connection with the example is included in at least one invention embodiment. Thus, appearances of the phrases “in an example” or “in an embodiment” in various places throughout this specification are not necessarily all referring to the same embodiment.

As used herein, a plurality of items, structural elements, compositional elements, and/or materials can be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various invention embodiments and examples can be referred to herein along with alternatives for the various components thereof. It is understood that such embodiments, examples, and alternatives are not to be construed as de facto equivalents of one another, but are to be considered as separate and autonomous representations under the present disclosure.

Furthermore, the described features, structures, or characteristics can be combined in any suitable manner in one or more embodiments. In the following description, numerous specific details are provided, such as examples of layouts, distances, network examples, etc., to provide a thorough understanding of invention embodiments. One skilled in the relevant art will recognize, however, that the technology can be practiced without one or more of the specific details, or with other methods, components, layouts, etc. In other instances, well-known structures, materials, or operations may not be shown or described in detail to avoid obscuring aspects of the disclosure.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device, which is more likely to have write errors to it than other regions in the same memory device. A number of factors can cause such increased risk, including location, fabrication process, number of program pulses applied to the region, etc.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases, depend on the specific context. However, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

Numerical amounts and data may be expressed or presented herein in a range format. It is to be understood, that such a range format is used merely for convenience and brevity, and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

As used herein, the term “circuitry” can refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Various techniques, or certain aspects or portions thereof, may take the form of program code (i.e., instructions) embodied in tangible media, such as floppy diskettes, compact disc-read-only memory (CD-ROMs), hard drives, transitory or non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “processor” can include general purpose processors, specialized processors such as VLSI, FPGAs, or other types of specialized processors, as well as base band processors used in transceivers to send, receive, and process wireless communications.

It should be understood that many of the functional units described in this specification may have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

An inertial measurement unit for use in a virtual reality device may include a magnet and a sensor hub. The magnet can be positioned at a fixed location while the sensor hub can move about the magnet. The sensor hub can include one or more accelerometers, one or more gyroscopes and a magnetometer. The inertial measurement unit can calculate position and orientation based on the acceleration sensed by the accelerometer, the angular velocity sensed by the gyroscope, and the distance from the magnet determined from a magnetic field strength sensed by the magnetometer. The position and orientation may be used to render stereoscopic video, stereoscopic audio and/or tactile outputs to create a virtual reality environment for a user.

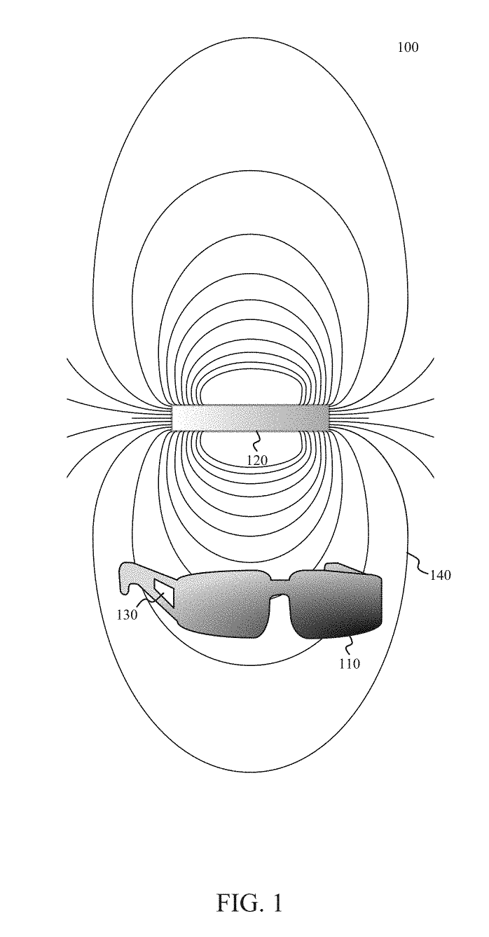

FIG. 1 is a diagram illustrating an exemplary system configured to determine a position and location. The system 100 can include a virtual reality device 110 and a magnetic field source 120. The virtual reality device 110 can have a form factor such as eyeglasses, goggles, headset, helmet, hand held game controller, hand held game console, tablet computer, smart phone or similar structure. The virtual reality device 110 can include one or more output interfaces such as one or more displays, one or more speakers, and/or one or more haptic feedback elements. When present, the one or more displays can be configured to display images (e.g., stereoscopic video) to a user. When present, the one or more speakers can be configured to output audio (e.g., stereoscopic audio) to a user. When present, the optional one or more haptic feedback elements can be configured to output one or more tactile outputs (e.g., vibrations) to a user.

The magnetic field source 120 can include nearly any device or material emitting a magnetic field of sufficient strength to reach the virtual reality device 110, such as a permanent magnet, an energized solenoid, an energized electromagnet, or similar magnetic source. The magnetic field source 120 can be positioned at a fixed location while the virtual reality device 110 can move about proximate the magnetic field source 120. The magnetic field of the magnet can be a dipole field, which decreases with distance from magnetic field source 120. A permanent magnet advantageously does not consume power. Although solenoids and electromagnets require power, their fixed position can permit use of a constant power supply, such as a common wall outlet.

The virtual reality device 110 can include an inertial measurement unit (IMU) 130. The inertial measurement unit 130 can be configured to determine a fixed position and orientation of the virtual reality device 110 from the acceleration of the virtual reality device 110, the angular velocity of the virtual reality device 110 and the strength of the magnetic field from the magnetic field source 120 at the virtual reality device 110.

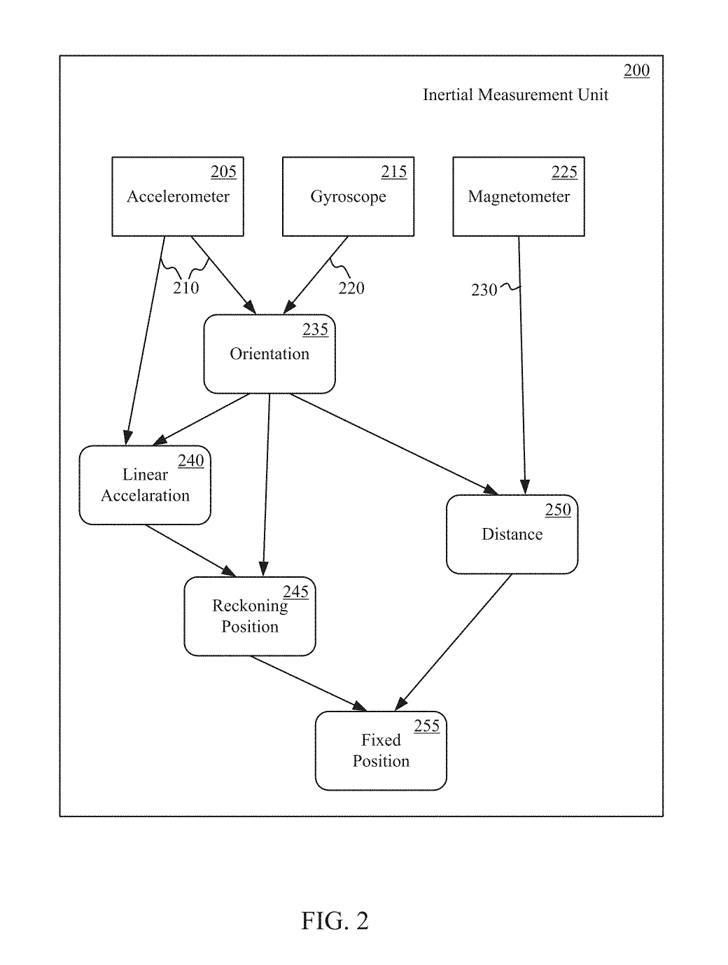

FIG. 2 is a diagram illustrating an inertial measurement unit (IMU) for determining a position and location of a device in accordance with an example. In one aspect, the inertial measurement unit 200 can include an accelerometer 205, a gyroscope 215, and a magnetometer 225 affixed to a device. The device may be a virtual reality headset, game controller, glove, or wearable article, or other similar device. The accelerometer 205 can be configured to sense acceleration 210 of the device. The gyroscope 215 can be configured to sense an angular velocity 220 of the device. The magnetometer 225 can be configured to sense a strength of a fixed magnetic field source 230 at the device.

In one aspect, the inertial measurement unit 200 can be configured to determine an orientation 235 of the device as a function of the acceleration 210 of the device and the angular velocity 220 of the device. In one instance, the value of the accelerometer (\vec{a}) is ideally the sum of the acceleration caused by gravity (\vec{g}) and the linear acceleration of the device (\vec{LA}). In addition, there is a constant offset of the sensor (\vec{a}_{offset}) and noise (WN). When the device is in a motionless state, the linear acceleration (\vec{LA}) is zero by definition, and by averaging over a number of points the noise (WN) impact is reduced, and therefore the gravity can be determined according to \vec{g}(t)=\vec{a}(t)−(\vec{a}_{offset}). One can also use the fact that the gravity norm value should be ˜9.81 m/sec² to improve the estimation of the sensor offset. Once the device starts to move, in order to follow the direction of the gravity, the gyroscope can be used. The gyroscope reading is the angular velocity of the device, and it can be transformed into a rotation matric Q(Δt), so that the change in the gravity is as follows:

\vec{g}(t+Δt)=Q(Δt)·\vec{g}(t)+Q(Δt)·\vec{a}_{offset}+\vec{δ}Q (1)

where the last two elements stand for the error in the gravity direction due to the offset in acceleration (Q(Δt)·\vec{a}_{offset}) and the error in the rotation matric (\vec{δ}Q). Over time, there is an increasing drift due to the gyroscope reading. In order to cope with this problem, a complementary filter can be employed. This filter uses the accelerometer values over long time periods to find the gravity direction, and the gyroscope values over short time periods to find the short term gravity direction, for corrections of the vertical angle, which is beneficial for estimation of the direction of gravity.

In one aspect, the inertial measurement unit 200 can also determine a linear acceleration 240 of the device as a function of the acceleration 210 of the virtual reality device and the orientation 235 of the virtual reality device. In one instance, once the direction of the gravity is known, the linear acceleration can be extracted by using equation (1) as follows:

\vec{LA}(t)=Q(t)·(\vec{a}(t)−\vec{g}(t)−\vec{a}_{offset}−WN) (2)

In a regular dead reckoning, the accuracy of the orientation is important. Equation (2) indicates why the divergence of the position will be very fast. For example, a 1° error in orientation will cause a relatively high acceleration also in a motionless state. The gravity has a minor projection of sine (1°)·9.8=0.171 m/sec², but after 10 seconds, it accumulates to 8.5 m error in the position. This clearly explains why having dead reckoning based on accelerometer and gyroscope only is not sufficient, and how incorporating magnetometer data can help.

In one aspect, the inertial measurement unit 200 can also determine a reckoning position 245 of the device as a function of the linear acceleration 240 of the device and the orientation 235 of the device. In one instance, once the linear acceleration at time t, \vec{LA}(t), is known, finding the change in the position \vec{r}(t+Δt) is done by using the initial condition at time t (e.g., velocity \vec{v}(t) and position \vec{r}(t)), which yields:

$$\vec{r} ( t + Δ t ) = \vec{r} ( t ) + \vec{v} ( t ) \cdot Δ t + \vec{LA} ( t ) \cdot \frac{Δ t 2}{2} \qquad ( 3 )$$

The linear acceleration was already rotated which increases the error of the position, as previously explained. The above method is a basic way to find the position, but it might cause first divergence with no way to restrain the divergence.

In one aspect, the inertial measurement unit 200 can also determine a distance 250 of the device from the fixed magnetic field source as a function of the magnetic field 230 and the orientation 235 of the device. The distance can be based upon an initial distance between the inertial measurement system 200 and the fixed magnetic field source received as an input to the inertial measurement unit 200, during a setup or configuration operation for example. In one instance, a magnet at a static position (\vec{r}_{M}) can be used, which will have an impact on the reading of the magnetic field proximate the magnetometer. The magnetic field can be approximately twice as much as the magnitude of the Earth's magnetic field or more, and its impact can be seen at a distance of 0.5 m or more. The magnetometer reading based on the distance from the external magnet can be

$${M}_{EM} ( \vec{r} ) = \frac{C}{r 3} ,$$

where C is a constant representing the strength of the external magnet. The reading of the magnetometer \vec{M}(\vec{r}) is:

\vec{M}(\vec{r})=\vec{M}_{Earth}+\vec{M}_{offset}+\vec{M}_{EM}(\vec{r}) (4)

where \vec{M}_{Earth} the Earth's magnetic field which is constant. Usually, the magnetometer has an offset (\vec{M}_{offset}) which is constant in the device frame. Therefore, when the device orientation is changing the Earth's magnetic field will rotate, while the offset would not change. Above this, there is the magnetic field caused by the external magnet (\vec{M}_{EM}(\vec{r})) which also rotates with the device. Therefore, if the device is rotated by Q(Δt) one gets:

\vec{M}(t+Δt)=Q(t)·(\vec{M}_{Earth}+\vec{M}_{EM}(\vec{r}))++\vec{M}_{offset} (5)

The external magnet component is the only element that is spatially dependent, and therefore it will be easy to use it as a measure of a fixed distance. When the device moves from point \vec{x} by \vec{δ}x without orientation changes, knowing that the distance between the inertial measurement unit and the external magnet is R, and assuming that the distance moved in a single time step is much smaller than the distance to the magnet, by using Tylor expansion, the change in the magnetometer reading can be expresses as:

$$δ X = \frac{R 4}{3 C} \cdot ( \vec{M} ( \vec{x} ) - \vec{M} ( \vec{x} + \vec{δ} X ) ) \qquad ( 6 )$$

In one aspect, the inertial measurement unit 200 can also determine a fixed position 255 of the device as a function of the reckoning position 245 of the device and the distance 250 of the device form the fixed magnetic field source. In one instance, combining equations (3), (5) and (6), an extended Kalman filter can be employed in order to provide a fixed position with a feedback on its location. The extended Kalman filter combines the dead reckoning, with the external magnetometer data, yielding real time device positioning with a feedback.

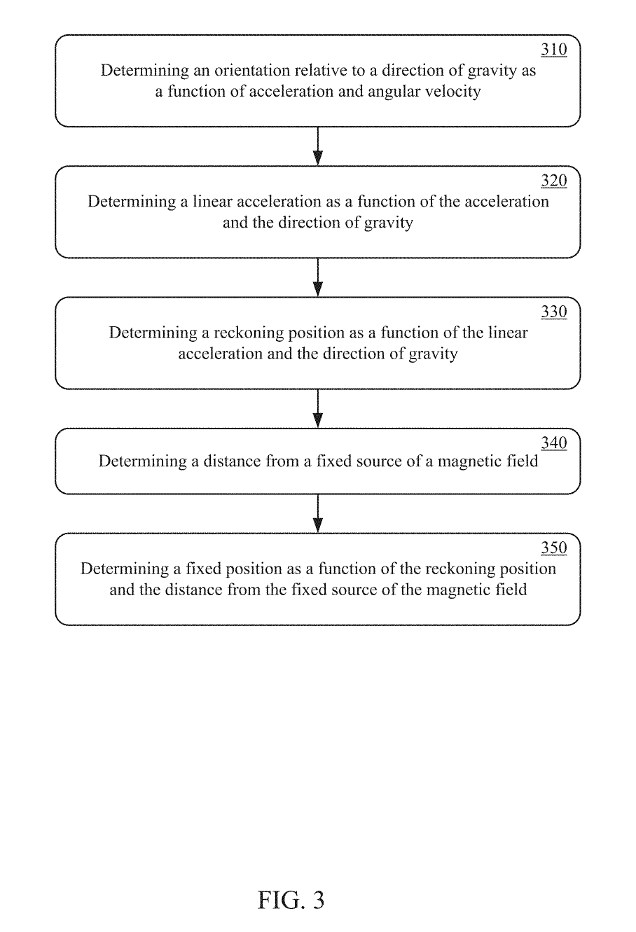

FIG. 3 is diagram illustrating a method for determining a position and location of a device in accordance with an example. Notably, some operations of such method have been previously mentioned in the context of an IMU. In one aspect, an orientation relative to a direction of gravity can be determined as a function of acceleration and angular velocity 310. In one instance, the value of the accelerometer (\vec{a}) is ideally the sum of the acceleration caused by gravity (\vec{g}) and the linear acceleration of the device (\vec{LA}). In addition, there is a constant offset of the sensor (\vec{a}_{offset}) and noise (WN). When the device is in a motionless state, the linear acceleration (\vec{LA}) is zero by definition, and by averaging over a number of points the noise (WN) impact is reduced, and therefore the gravity can be determined according to \vec{g}(t)=\vec{a}(t)−(\vec{α}_{offset}). One can also use the fact that the gravity norm value should be ˜9.81 m/sec² to improve the estimation of the sensor offset. Once the device starts to move, in order to follow the direction of the gravity, the gyroscope can be used. The gyroscope reading is the angular velocity of the device, and it can be transformed into a rotation matric Q(Δt), so that the change in the gravity is as follows:

\vec{g}(t+Δt)=Q(Δt)·\vec{g}(t)+Q(Δt)·\vec{a}_{offset}+\vec{δ}Q (1)

where the last two elements stand for the error in the gravity direction due to the offset in acceleration (Q(Δt)·\vec{a}_{offset}) and error in the rotation matric (\vec{δ}Q). Over time, there is an increasing drift due to the gyroscope reading. In order to cope with this problem, a complementary filter can be employed. This filter uses the accelerometer values over long time periods to find the gravity direction, and the gyroscope values over short time periods to find the short term gravity direction, for corrections of the vertical angle, which is beneficial for estimation of the direction of gravity.

In one aspect, a linear acceleration can be determined as a function of the acceleration and the direction of gravity 320. In one instance, once the direction of the gravity is known, the linear acceleration can be extracted by using equation (1) as follows:

\vec{LA}(t)=Q(t)·(\vec{a}(t)−\vec{g}(t)−\vec{a}_{offset}−WN) (2)

In a regular dead reckoning, the accuracy of the orientation is important. Equation (2) indicates why the divergence of the position will be very fast. For example, a 1° error in orientation will cause a relatively high acceleration also in a motionless state. The gravity has a minor projection of sine (1°)·9.8=0.171 m/sec², but after 10 seconds, it accumulates to 8.5 m error in the position. This clearly explains why having dead reckoning based on accelerometer and gyroscope only is not sufficient, and how incorporating magnetometer data can help.

In one aspect, a reckoning position can be determined as a function of the linear acceleration and the direction of gravity 330. In one instance, once the linear acceleration at time t, \vec{LA}(t), is known, finding the change in the position \vec{a}(t+Δt) is done by using the initial condition at time t (e.g., velocity \vec{v}(t) and position \vec{r}(t)), which yields:

$$\vec{r} ( t + Δ t ) = \vec{r} ( t ) + \vec{v} ( t ) \cdot Δ t + \vec{LA} ( t ) \cdot \frac{Δ t 2}{2} \qquad ( 3 )$$

The linear acceleration was already rotated which increases the error of the position, as previously explained. The above method is a basic way to find the position, but it might cause first divergence with no way to restrain the divergence.

In one aspect, a distance from a fixed source of a magnetic field can be determined 340. In one instance, a magnet at a static position (\vec{r}_{M}) can be used, which will have an impact on the reading of the magnetic field proximate the magnetometer. The magnetic field can be approximate 1.25 Tesla or more, and its impact can be seen at a distance of 0.5 m or more. The magnetometer reading based on the distance from the external magnet can be

$${M}_{EM} ( \vec{r} ) = \frac{C}{r 3} ,$$

where C is a constant representing the strength of the external magnet. The reading of the magnetometer \vec{M}(\vec{r}) is:

\vec{M}(\vec{r})=\vec{M}_{Earth}+\vec{M}_{offset}+\vec{M}_{EM}(\vec{r}) (4)

where \vec{M}_{Earth} the Earth's magnetic field which is constant. Usually, the magnetometer has an offset (\vec{M}_{offset}) which is constant in the device frame. Therefore, when the device orientation is changing the Earth's magnetic field will rotate, while the offset would not change. Above this, there is the magnetic field caused by the external magnet (\vec{M}_{EM}(\vec{r})) which also rotates with the device. Therefore, if the device is rotated by Q(Δt) one gets:

\vec{M}(t+Δt)=Q(t)·(\vec{M}_{Earth}+\vec{M}_{EM}(\vec{r}))++\vec{M}_{offset} (5)

The external magnet component is the only element that is spatially dependent, and therefore it will be easy to use it as a measure of a fixed distance. When the device moves from point \vec{x} by \vec{δ}x without orientation changes, knowing that the distance between the inertial measurement unit and the external magnet is R, and assuming that the distance moved in a single time step is much smaller than the distance to the magnet, by using Tylor expansion, the change in the magnetometer reading can be expresses as:

$$δ X = \frac{R 4}{3 C} \cdot ( \vec{M} ( \vec{x} ) - \vec{M} ( \vec{x} + \vec{δ} X ) ) \qquad ( 6 )$$

In one aspect, a fixed position can be determined as a function of the reckoning position and the distance from the fixed source of the magnetic field 350. In one instance, combining equations (3), (5) and (6), an extended Kalman filter can be employed in order to provide a fixed position with a feedback on its location. The extended Kalman filter, combines the dead reckoning, with the external magnetometer data, yielding real time device positioning with a feedback.

The above describe method 310-350 can be iteratively repeated to update the determined position and location of the device.

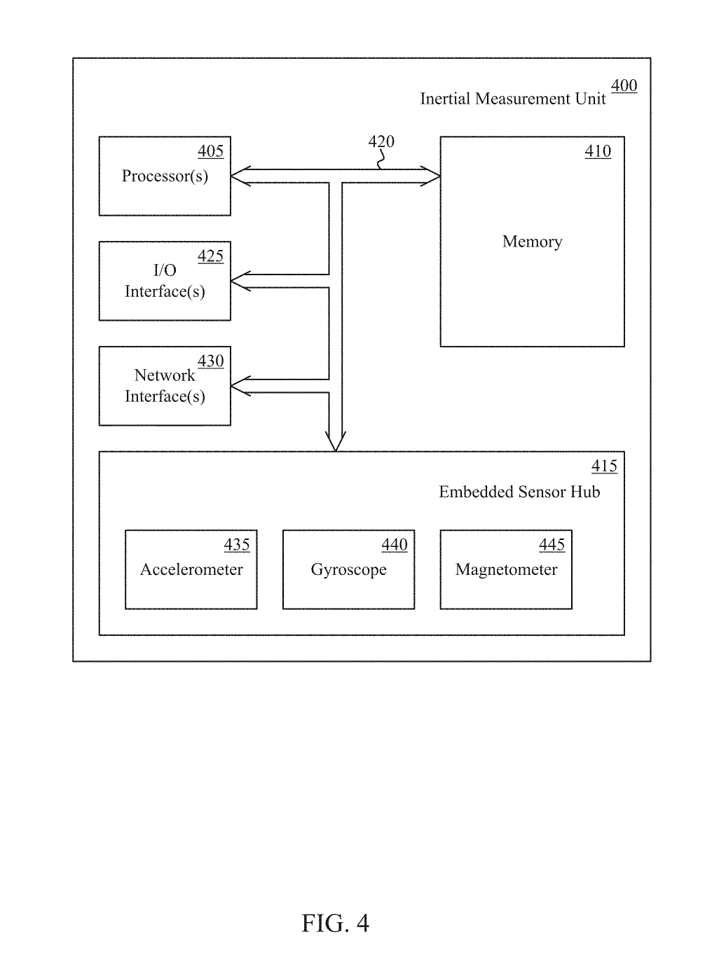

FIG. 4 is a diagram illustrating an inertial measurement unit for determining a position and location of a device in accordance with another example. The inertial measurement unit 400 can include one or more processors 405, one or more memory units 410 and an embedded sensor hub 415 communicatively coupled together by one or more buses 420. The inertial measurement unit 400 can also include one or more input/output interfaces 425, one or more network interfaces 430, and other subsystems communicatively coupled to the one or more buses 420.

The embedded sensor hub 415 can include one or more accelerometers 435, one or more gyroscopes 440, and one or more magnetometers 445. The accelerometer 435 can be configured to sense acceleration of the embedded sensor hub 415. The gyroscope 440 can be configured to sense an angular velocity of the embedded sensor hub 415. The magnetometer 445 can be configured to sense a strength of a fixed magnetic field source at the embedded sensor hub 415. The embedded sensor hub 415 can periodically sense the acceleration, angular velocity and magnetic field strength.

The memory 410 can store one or more sets of computing device executable instructions (e.g., software) that when executed by the one or more processors 405 can determine the position and location of the inertial measurement unit 400 and/or the embedded sensor hub 415. Determining the position and location can include determining an orientation relative to a direction of gravity based on the sensed acceleration received from the accelerometer 435 and the sensed angular velocity received from the gyroscope 440. A linear acceleration can be determined based on the sensed acceleration received from the accelerometer 435 and the determined orientation. A reckoning position can be determined based on the determined linear acceleration and orientation. A distance from a fixed source of a magnetic field can be determined based on the sensed strength of the fixed magnetic field source from the magnetometer 445 and the determined orientation. A fixed position can be determined based on the determined reckoning position and the determined distance from the fixed source of the magnetic field. The orientation, linear acceleration, reckoning position, distance and fixed position can each be determined periodically.

In one aspect, the determined orientation and fixed position can be output through a network interface 430 to one or more other computing devices or subsystem. In one instance the determined orientation and fixed position can be used by one or more other computing devices or subsystems to render images (e.g., video), audio, or tactile outputs as a function of the orientation and fixed position of the inertial measurement unit 400.

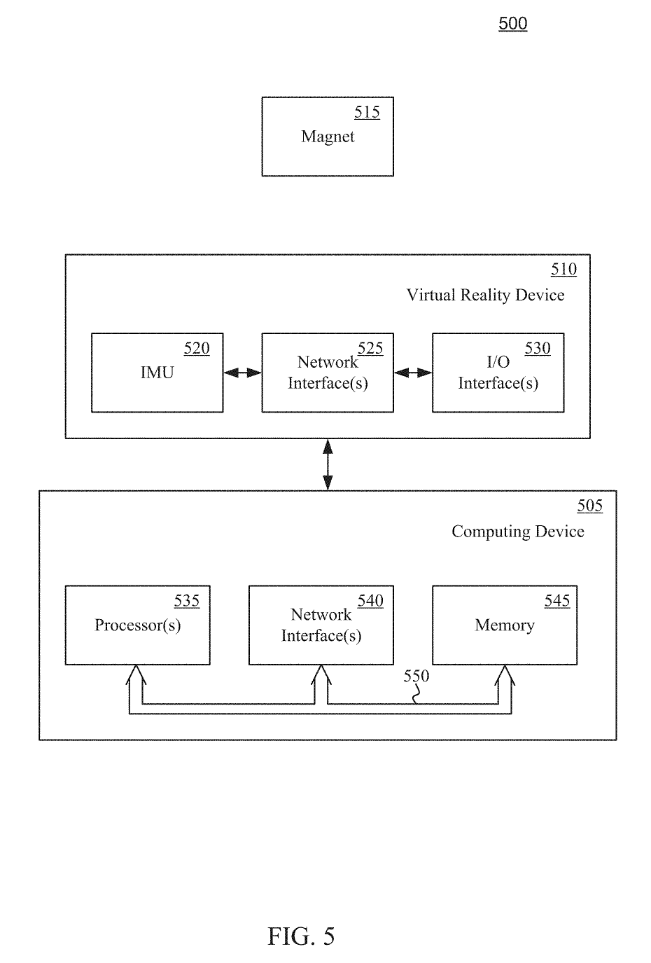

FIG. 5, is a diagram illustrating a system configured to determine a position and location in accordance with another example. The system 500 includes a computing device 505, a virtual reality device 510 and a magnet 515. The computing device 505 may be a game console, set top box, personal computer (PC), laptop computer, tablet computer, smart phone or similar device. The virtual reality device 510 may be a virtual reality headset, game controller, or other similar device. The magnet 515 may be a permanent magnet, an energized solenoid, an energized electromagnet, or similar magnetic source.

The magnet 515 can be positioned at a fixed location, while the virtual reality device 510 can move about proximate the magnet 515. A permanent magnet advantageously does not consume power. Although solenoids and electromagnets require power, their fixed position can permit use of a constant power supply, such as a common wall outlet. The location of the magnet does not change over time. However, it is to be understood that the fixed location of the magnet can be established or re-established depending on the location in which a user wishes to use the virtual reality system. For example, the magnet may be moved from a first location (e.g. a first room of a building) in which a user is using a virtual reality system, to a second location (e.g. a second room of the building) when the user desires to relocate his or her use of the virtual reality system. In some embodiments, the magnet 515, can be located within, or otherwise attached to a computing device 505.

The virtual reality device 510 can include an inertial measurement unit 520, one or more network interfaces 525, and one or more input/output interface 530. In one aspect, the inertial measurement unit (IMU) 520 can determine the position and location of the virtual reality device 510. Determining the position and location can include determining an orientation relative to a direction of gravity based on the acceleration and the angular velocity of the virtual reality device 510. A linear acceleration can be determined based on the acceleration of the virtual reality device 510 and the determined orientation. A reckoning position can be determined based on the determined linear acceleration and orientation. A distance from the magnet 515 can be determined based on the strength of the magnetic field from the magnet 515 at the virtual reality device 510 and the determined orientation. A fixed position of the virtual reality device 510 can be determined based on the determined reckoning position and the determined distance from the fixed magnet 515. The orientation, linear acceleration, reckoning position, distance and fixed position can be periodically determined at a predetermined rate.

In one aspect, the virtual reality device 510 can output the determined orientation and fixed position, through a network interface 525, to the computing device 505. The computing device can include one or more processors 535, one or more memory units 540, one or more network interface 545, and any other applicable subsystem communicatively coupled together by one or more buses 550. The network interface 545 of the computing device can receive the determined orientation and fixed position of the virtual reality device 510. The memory 540 can include one or more set of computing device executable instructions that when executed by the processor 535 can render one or more images, audio, tactile responses, or similar outputs as a function of the determined fixed position, and optionally the determined orientation, of the virtual reality device 510. The one or more images, audio, tactile responses or similar outputs can be output, through the network interface 545 of the computing device 505.

The images, audio, tactile responses or similar outputs rendered as a function of the determined fixed position, and optionally the determine orientation can be received by the network interface 525 of the virtual reality device. In one instance, images rendered as a function of the determined fixed position of the virtual reality device 510 (e.g., 3D rendered video) can be output on one or more display type input/output devices 530. In another instance, audio rendered as a function of the determined fixed position of the virtual reality device 510 (e.g., stereoscopic audio) can be output on a plurality of speaker type input/output devices 530. In yet another instance, tactile responses rendered as a function of the determined fixed position of the virtual reality device 510 (e.g., vibrations, force, torque) can be output on one or more haptic feedback type input/output device 530.

The IMU 520 can be configured to determine an orientation of the device as a function of the acceleration of the virtual reality device and the angular velocity of the device. The IMU 520 can also determine a linear acceleration of the device as a function of the acceleration of the virtual reality device and the orientation of the virtual reality device. The IMU 520 can also determine a reckoning position of the device as a function of the linear acceleration of the device and the orientation of the device. The IMU 520 can also determine a distance of the device from the fixed magnetic field source as a function of the magnetic field. The IMU 520 can also determine a fixed position of the device as a function of the reckoning position of the device and the distance of the device form the fixed magnetic field source.

### EXAMPLES

The following examples pertain to specific technology embodiments and point out specific features, elements, or steps that may be used or otherwise combined in achieving such embodiments.

In one example there is provided, a method for determining a position including

determining, periodically at a predetermined rate, an orientation relative to a direction of gravity as a function of acceleration and angular velocity;

determining, periodically at the predetermined rate, a linear acceleration as a function of the acceleration and the direction of gravity;

determining, periodically at the predetermined rate, a reckoning position as a function of the linear acceleration and the direction of gravity;

determining, periodically at the predetermined rate, a distance from a fixed source of a magnetic field; and

determining, periodically at the predetermined rate, a fixed position as a function of the reckoning position and the distance from the fixed source of the magnetic field.

In one example of a method for determining a position, the method further comprises rendering images as a function of the periodically determined fixed position.

In one example of a method for determining a position, the method further comprises rendering the images as a function of the periodically determined orientation.

In one example of a method for determining a position, the method further comprises rendering audio as a function of the periodically determined fixed position.

In one example of a method for determining a position, the method further comprises rendering haptic feedback as a function of the periodically determined fixed position.

In one example of a method for determining a position, determining, periodically at the predetermined rate, the distance from the fixed source of the magnetic field includes, determining a distanced moved in a time step as a function of a change in the fixed magnetic field for the time step and as a function of an initial distance between the fixed magnetic field source and the virtual reality device.

In one example of a method for determining a position, determining, periodically at the predetermined rate, the fixed position as a function of the reckoning position and the distance from the fixed source of the magnetic field includes, linear quadratic estimation filtering the reckoning position and the distance of the device from the source of the fixed magnetic field.

In one example of a method for determining a position, determining, periodically at the predetermined rate, the orientation relative to the direction of gravity as a function of the acceleration due to gravity and the angular velocity includes, filtering the acceleration of a first period of time and the angular velocity of a second period of time, wherein the first period of time is longer than the second period of time.

In one example of a method for determining a position, determine, periodically at a predetermined rate, the orientation relative to the direction of gravity includes, aligning a rotation of the direction of gravity to a world reference frame.

In one example there is provided, a device for determining a position comprising:
an accelerometer configured to sense an acceleration of the device;
a gyroscope configured to sense an angular velocity of the device;
a magnetometer configured to sense a magnetic field at the device; and
one or more processors and memory configured to,
   determine a direction of gravity relative to the device as a function of the sensed acceleration of the device and the sensed angular velocity of the device;
   determine a linear acceleration of the device as a function of the sensed acceleration of the device and the direction of gravity relative to the device;
   determine a reckoning position of the device as a function of the linear acceleration of the device and the direction of gravity relative to the device;
   determine a distance of the device from a fixed source of the magnetic field as a function of the sensed magnetic field; and
   determine a fixed position of the device as a function of the reckoning position of the device and the distance of the device from the fixed source of the magnetic field.

In one example of a device for determining a position, the one or more processors and memory are further configured to, determine an orientation of the device as a function of the direction of the gravity relative to the device.

In one example of a device for determining a position, the one or more processors and memory are further configured to, receive an input indicating an initial distance between the device and the fixed source of the magnetic field.

In one example of a device for determining a position, determine the distance of the device from the fixed source of the magnetic field includes, determine a distanced moved in a time step as a function of the initial distance between the device and the fixed source of the magnetic field and as a function of a change in the sensed magnetic field for the time step.

In one example of a device for determining a position, the one or more processors and memory configured to determine the fixed position of the device as a function of the reckoning position of the device and the distance of the device from the fixed source of the magnetic field includes, linear quadratic estimation filter the reckoning position and the distance of the device from the source of the fixed magnetic field.

In one example of a device for determining a position, the one or more processors and memory configured to determine the direction of gravity as the function of the sensed acceleration of the device and the sensed angular velocity of the device includes, filters the sensed acceleration of a first period of time and the sensed angular velocity of a second period of time, wherein the first period of time is longer than the second period of time.

In one example of a device for determining a position, the fixed magnetic field sensed at the device has a magnitude that is at least twice as much as the magnitude of Earth's magnetic field.

In one example there is provided a system for determining a position comprising:

a fixed magnetic field source; and

a virtual reality device including,

an accelerometer configured to sense acceleration of the virtual reality device;

a gyroscope configured to sense an angular velocity of the virtual reality device;

a magnetometer configured to sense a magnetic field of the fixed magnetic field source at the virtual reality device; and

an inertial measurement unit configured to,
determine an orientation of the virtual reality device as a function of the acceleration of the virtual reality device and the angular velocity of the device;
determine a linear acceleration of the virtual reality device as a function of the acceleration of the virtual reality device and the orientation of the virtual reality device;
determine a reckoning position of the virtual reality device as a function of the linear acceleration of the virtual reality device and the orientation of the device;
determine a distance of the virtual reality device from the fixed magnetic field source as a function of the magnetic field;
determine a fixed position of the virtual reality device as a function of the reckoning position of the virtual reality device and the distance of the virtual reality device from the fixed magnetic field source.

In one example of a system for determining a position, the inertial measurement unit configured to determine the distance of the virtual reality device from the fixed magnetic field source as a function of the sensed magnetic field includes, the inertial measurement unit further configured to determine a distance moved in a time step as a function of a change in the sensed fixed magnetic field for the time step and as a function of an initial distance between the fixed magnetic field source and the virtual reality device

In one example of a system for determining a position, the fixed magnetic field source includes a permanent magnet at a fixed location.

In one example of a system for determining a position, the fixed magnetic field source includes an energized solenoid at a fixed location.

In one example of a system for determining a position, the fixed magnetic field source includes an energized electromagnet at a fixed location.

In one example of a system for determining a position, the virtual reality device further includes: one or more displays configured to display images rendered as a function of the fixed position and orientation of the virtual reality device.

In one example of a system for determining a position, the virtual reality device further includes: a network interface for receiving images rendered as a function of the fixed position and orientation of the virtual reality device.

In one example of a system for determining a position, the virtual reality device further includes: a network interface for transmitting an indication of the fixed position and the orientation of the virtual reality device.

In one example of a system for determining a position, the virtual reality device further includes: one or more speakers for rendering audio as a function of the fixed position and orientation of the virtual reality device.

In one example of a system for determining a position, the virtual reality device further includes: one or more haptic elements for rendering haptic feedback as a function of the fixed position and orientation of the virtual reality device.

In one example of a system for determining a position, the virtual reality device is a virtual reality headset.

In one example of a system for determining a position, the virtual reality device is a handheld controller.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology.

What is claimed is:

1. A method for determining a position comprising:
determining, periodically at a predetermined rate, an orientation relative to a direction of gravity as a function of acceleration and angular velocity;
determining, periodically at the predetermined rate, a linear acceleration as a function of the acceleration and the direction of gravity;
determining, periodically at the predetermined rate, a reckoning position as a function of the linear acceleration and the direction of gravity;
determining, periodically at the predetermined rate, a distance from a fixed source of a magnetic field; and
determining, periodically at the predetermined rate, a fixed position as a function of the reckoning position and the distance from the fixed source of the magnetic field.

2. The method according to claim 1, further comprising rendering images as a function of the periodically determined fixed position.

3. The method according to claim 2, further comprising rendering the images as a function of the periodically determined orientation.

4. The method according to claim 1, further comprising rendering audio as a function of the periodically determined fixed position.

5. The method according to claim 1, further comprising rendering haptic feedback as a function of the periodically determined fixed position.

6. The method according to claim 1, wherein determining, periodically at the predetermined rate, the distance from the fixed source of the magnetic field includes,
determining a distanced moved in a time step as a function of a change in the fixed magnetic field for the time step and as a function of an initial distance between the fixed magnetic field source and the virtual reality device.

7. The method according to claim 1, wherein determining, periodically at the predetermined rate, the fixed position as a function of the reckoning position and the distance from the fixed source of the magnetic field includes,
linear quadratic estimation filtering the reckoning position and the distance of the device from the source of the fixed magnetic field.

8. The method according to claim 1, wherein determining, periodically at the predetermined rate, the orientation relative to the direction of gravity as a function of the acceleration due to gravity and the angular velocity includes,
filtering the acceleration of a first period of time and the angular velocity of a second period of time, wherein the first period of time is longer than the second period of time.

9. The method according to claim 1, wherein determine, periodically at a predetermined rate, the orientation relative to the direction of gravity includes, aligning a rotation of the direction of gravity to a world reference frame.

10. A device for determining a position comprising:
an accelerometer configured to sense an acceleration of the device;
a gyroscope configured to sense an angular velocity of the device;
a magnetometer configured to sense a magnetic field at the device; and
one or more processors and memory configured to,
determine a direction of gravity relative to the device as a function of the sensed acceleration of the device and the sensed angular velocity of the device;
determine a linear acceleration of the device as a function of the sensed acceleration of the device and the direction of gravity relative to the device;
determine a reckoning position of the device as a function of the linear acceleration of the device and the direction of gravity relative to the device;
determine a distance of the device from a fixed source of the magnetic field as a function of the sensed magnetic field; and
determine a fixed position of the device as a function of the reckoning position of the device and the distance of the device from the fixed source of the magnetic field.

11. The device of claim 10, wherein the one or more processors and memory are further configured to,
determine an orientation of the device as a function of the direction of the gravity relative to the device.

12. The device of claim 10, wherein the one or more processors and memory are further configured to,
receive an input indicating an initial distance between the device and the fixed source of the magnetic field.

13. The device of claim 10, wherein determine the distance of the device from the fixed source of the magnetic field includes, determine a distanced moved in a time step as a function of the initial distance between the device and the fixed source of the magnetic field and as a function of a change in the sensed magnetic field for the time step.

14. The device of claim 10, wherein the one or more processors and memory configured to determine the fixed position of the device as a function of the reckoning position of the device and the distance of the device from the fixed source of the magnetic field includes,
linear quadratic estimation filter the reckoning position and the distance of the device from the source of the fixed magnetic field.

15. The device of claim 10, wherein the one or more processors and memory configured to determine the direction of gravity as the function of the sensed acceleration of the device and the sensed angular velocity of the device includes,
filters the sensed acceleration of a first period of time and the sensed angular velocity of a second period of time, wherein the first period of time is longer than the second period of time.

16. The device of any one of claim 10, wherein the fixed magnetic field sensed at the device has a magnitude that is at least twice as much as the magnitude of Earth's magnetic field.

17. An system for determining a position comprising:
a fixed magnetic field source; and
a virtual reality device including,
an accelerometer configured to sense acceleration of the virtual reality device;
a gyroscope configured to sense an angular velocity of the virtual reality device;
a magnetometer configured to sense a magnetic field of the fixed magnetic field source at the virtual reality device; and
an inertial measurement unit configured to,
determine an orientation of the virtual reality device as a function of the acceleration of the virtual reality device and the angular velocity of the device;
determine a linear acceleration of the virtual reality device as a function of the acceleration of the virtual reality device and the orientation of the virtual reality device;
determine a reckoning position of the virtual reality device as a function of the linear acceleration of the virtual reality device and the orientation of the device;
determine a distance of the virtual reality device from the fixed magnetic field source as a function of the magnetic field;
determine a fixed position of the virtual reality device as a function of the reckoning position of the virtual reality device and the distance of the virtual reality device from the fixed magnetic field source.

18. The system of claim 17, wherein the inertial measurement unit configured to determine the distance of the virtual reality device from the fixed magnetic field source as a function of the sensed magnetic field includes,
the inertial measurement unit further configured to determine a distance moved in a time step as a function of a change in the sensed fixed magnetic field for the time step and as a function of an initial distance between the fixed magnetic field source and the virtual reality device.

19. The system of claim 17, wherein the fixed magnetic field source includes a permanent magnet at a fixed location.

20. The system of claim 17, wherein the fixed magnetic field source includes an energized solenoid at a fixed location.

21. The system of claim 17, wherein the fixed magnetic field source includes an energized electromagnet at a fixed location.

22. The system of claim 17, wherein the virtual reality device further includes:
one or more displays configured to display images rendered as a function of the fixed position and orientation of the virtual reality device.

23. The system of claim 22, wherein the virtual reality device further includes:
a network interface for receiving images rendered as a function of the fixed position and orientation of the virtual reality device.

24. The system of claim 17, wherein the virtual reality device further includes:
a network interface for transmitting an indication of the fixed position and the orientation of the virtual reality device.

25. The system of claim 17, wherein the virtual reality device further includes:
one or more speakers for rendering audio as a function of the fixed position and orientation of the virtual reality device.

26. The system of claim 17, wherein the virtual reality device further includes:
one or more haptic elements for rendering haptic feedback as a function of the fixed position and orientation of the virtual reality device.

27. The system of claim 17, wherein the virtual reality device is a virtual reality headset.

28. The system of claim 17, wherein the virtual reality device is a handheld controller.
